(19) United States
(12) Patent Application Publication
(10) Pub. No.: US 2006/0180563 A1
(43) Pub. Date: Aug. 17, 2006

(54) Method of operating a machine

(75) Inventor: David John Knight, Cheddleton (GB)

Correspondence Address: ECKERT SEAMANS CHERIN & MELLOTT, 600 GRANT STREET, 44TH FLOOR, PITTSBURGH, PA, 15219, US

(73) Assignee: J.C. Bamford Excavators Limited

(21) Appl. No.: 11/185,954

(22) Filed: Jul. 20, 2005

(30) Foreign Application Priority Data
Jul. 22, 2004 (GB) GB 0416336.6

(51) Int. Cl. B66C 23/68

(52) U.S. Cl. 212/299

(57) ABSTRACT

A method of operating a machine which has a boom mounted at or adjacent one end to a body of the machine, and the boom having at the other end, a load handling implement, the boom including at least two sections with one of the sections, being telescoped within the other, there being at least one extension actuator to adjust the extent of telescoping, and the boom being moveable by at least one lift actuator for movement between a lowered position to a raised position, the method including preventing the relative extension of the boom sections to provide a minimum overlap between the boom sections when the boom is at the lowered position which is greater than the minimum overlap permitted when the boom is at a raised position.

### BACKGROUND TO THE INVENTION

This invention relates to a method of operating a machine of the kind which has a boom mounted at or adjacent one end to a body of the machine, and the boom having at the other end, a load handling implement. More particularly the invention relates to such a method where the boom includes at least two sections, with one of the sections, usually the section outermost of the body, being telescoped within the other or next innermost section, there being one or more extension actuators to adjust the extend of telescoping.

The boom is moveable by one or more lift actuators, usually about a pivot axis where the boom is mounted on the body, for movement between a lowered position at which a load carried by the load handling implement is positioned at or adjacent ground level, to a raised position at which the load may be placed or from where a load may be received.

It will be appreciated that there is an overlap between the telescoped boom sections which is at a maximum when the boom sections are fully relatively retracted, and at a minimum when the boom sections are fully relatively extended.

The boom sections are prevented e.g. by stops or by the design of the extension actuator or actuators, from being relatively extended beyond a position in which there is a minimum overlap between the boom sections, the extent of minimum overlap being determined for a maximum rated load when the boom is in its lowered position, when the forces acting on the structure of the boom where the sections overlap, e.g. on wear pads between the sections, are at a maximum, and forces tending to tip the machine e.g. about a front axle of the machine (where the boom is forwardly extending) tend to be at a maximum.

However it will be appreciated that when the boom is raised about the pivot axis when fully extended, the forces on the boom structurally and tipping forces, will be less than when the boom is at its lowered position when the minimum extent of overlap permitted by the design, was determined.

### SUMMARY OF THE INVENTION

According to one aspect of the invention we provide a method of operating a machine which has a boom mounted at or adjacent one end to a body of the machine, and the boom having at the other end, a load handling implement, the boom including at least two sections, with one of the sections, being telescoped within the other, there being at least one extension actuator to adjust the extent of telescoping, and the boom being moveable by at least one lift actuator for movement between a lowered position to a raised position, the method including preventing the relative extension of the boom sections to provide a minimum overlap between the boom sections when the boom is at the lowered position which is greater than the minimum overlap permitted when the boom is at a raised position.

By performing the method of the present invention, the boom sections may relatively be extended further when the boom is raised and the forces on the boom structure, and tipping forces exerted, are less than those forces would be when the boom is at its lowered position for the same relative extension. Thus a machine with extended upward reach may be provided, compared with a machine with a boom of the same general length, in which the minimum overlap permitted between the boom sections is the same for all boom positions.

The method of the invention may be performed by different means.

In a first embodiment, the method may include mechanically adjusting the boom geometry to reduce the permitted minimum overlap between the boom sections as the boom is raised. For example the extension actuator for relatively extending and retracting the boom sections may be mounted at one end relative to the first boom section and at the other end relative to the second boom section, one of the first and second actuator mounting positions being moved relative to the respective boom section, as the boom is raised or lowered. For example, a linear actuator may be provided within the boom, one of the mounting positions being moveable linearly of the boom as the boom is raised or lowered, by a linkage mechanism between the actuator and the body of the machine.

In one example, the linkage mechanism may include a simple link which extends directly between the actuator and the body of the machine, whereas in another example, the linkage mechanism includes a first link which extends between the actuator and an intermediate element to which the first link is pivotally connected, and a second link pivotally connected to the intermediate element and the body of the machine, the intermediate element being pivotally connected to the first boom section.

In another embodiment, the method may include adjusting the boom geometry hydraulically to reduce the permitted minimum overlap between the boom sections as the boom is raised. For example the lift actuator may be a liner actuator having a cylinder and a piston slidable therein, hydraulically operated to raise and lower the boom and/or there may be a displacement linear actuator including a piston and cylinder which are relatively moved as the boom is raised and lowered to displace hydraulic fluid, e.g. for use in maintaining the load handling implement, where provided, at a set attitude relative to ground as the boom is raised and lowered, the method including directing hydraulic fluid from the lift and/or displacement actuator, to an overlap actuator which adjusts the boom geometry as the boom is raised or lowered.

In one construction, the extension actuator for relatively extending and retracting the boom sections includes a cylinder having a first section isolated from a second section, the first section and a first piston slidable in the first section, providing the overlap actuator and the second cylinder section and a second piston slidable within the second section providing the extension actuator, one side of the first piston being connected hydraulically to one side of the piston of the lift or displacement actuator, so that the positions of the respective pistons are interdependent.

Where the boom includes more than two telescoped sections, each of the sections may be extendible relative to the next adjacent section by respective extension actuator, and at least one of the extension actuators may be extended or retracted to vary the amount of minimum permitted overlap between the adjacent boom sections, by hydraulic fluid displaced from another extension actuator or from the lift and/or displacement actuator.

In yet another embodiment of the invention, the method may include adjusting the boom geometry electro-hydraulically to reduce the permitted minimum overlap between the boom sections as the boom is raised. For example, the extension actuator may be capable of relatively extending the boom sections at all boom lift positions so as to provide the minimum overlap between the boom sections which is required when the boom is in its fully raised position, extension actuator extension being restricted by a controller for all lifting positions below the fully raised positions in response to inputs from sensors which sense the actual relative extension of the boom sections and the position of the boom between its raised and lowered positions.

Such sensors may include a linear encoder to determine the axial position of a piston in a cylinder where the lift and/or extension actuator is a linear actuator, and/or a rotary encoder provided for example at the pivot mounting where the boom is mounted to the body of the machine, or any other suitable, preferably solid state sensor, and/or an encoder to determine the actual extent of telescoping of the first and second boom sections.

If desired, the controller may control the extension actuator operation to vary the amount of permitted minimum overlap depending upon the magnitude of a load carried by the boom, as well as the position of the boom between the raised and lowered positions, and the extent of extension of the extension actuator.

According to a second aspect of the invention we provide a machine having a boom for handling loads for use in the method of the first aspect of the invention.

### BRIEF DESCRIPTION OF THE DRAWINGS

Embodiments of the invention will now be described with reference to the accompanying drawings in which:—

FIG. 1 is an illustrative view of a load handling machine which may be operated by the method of the invention;

FIG. 2 is an illustrative view of part of the machine of FIG. 1 showing a mechanism for performing the method of the invention;

FIG. 2a is a view similar to that of FIG. 2, but of a modified arrangement, and

FIG. 3 is a view similar to FIG. 3 but of an alternative embodiment.

### DESCRIPTION OF THE PREFERRED EMBODIMENTS

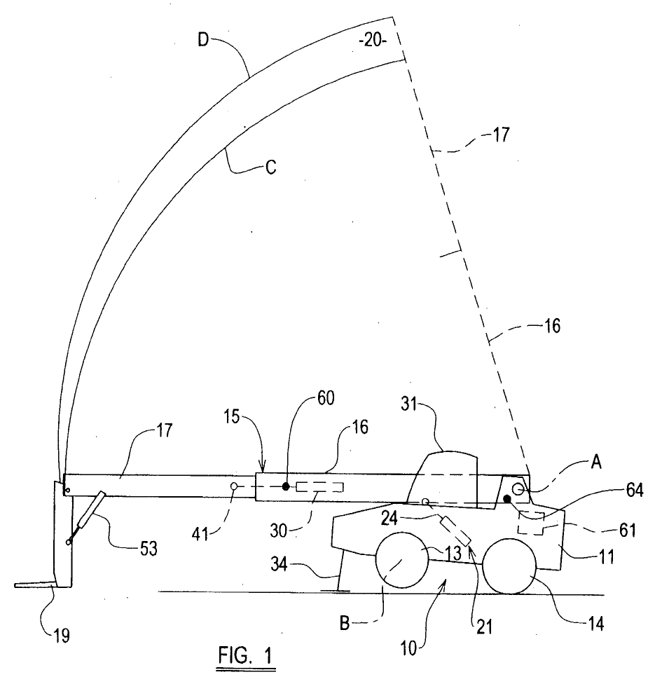

Referring to FIG. 1 there is shown a machine which is known as a wheeled loader 10 or telescopic handler, the machine having a body 11 carried on two pairs of wheels 13, 14 the body 11 having mounted thereon, a boom 15.

The boom 15 in the example of FIG. 1 is a two section boom. A first section 16 is pivotally mounted on the body 11 for movement about a generally horizontal axis A between a lowered position and a raised position. The second boom section 17 is telescoped within the first boom section 16 as will be described in more detail below, and the second boom section 17 carries at its outermost end, a load handling implement such as the loading forks 19 indicated.

When the boom 15 is in a lowered position, as shown in full lines, a load carried by the implement 19 is on or adjacent the ground, and when the boom 15 is raised, the load may be raised to or lowered from a high position, indicated at 20.

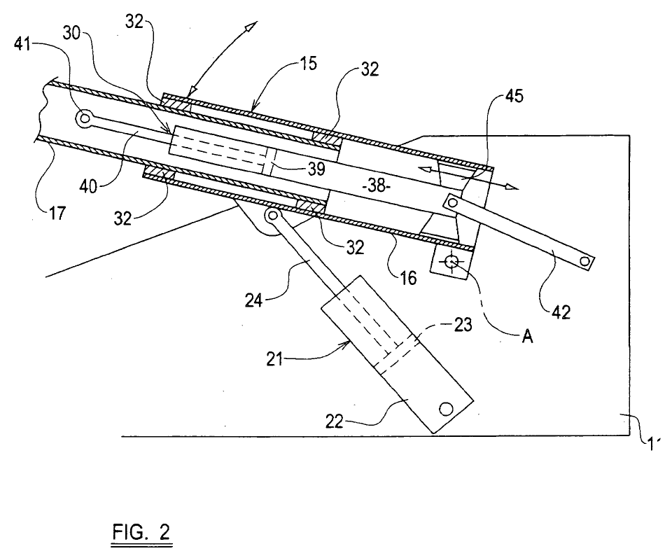

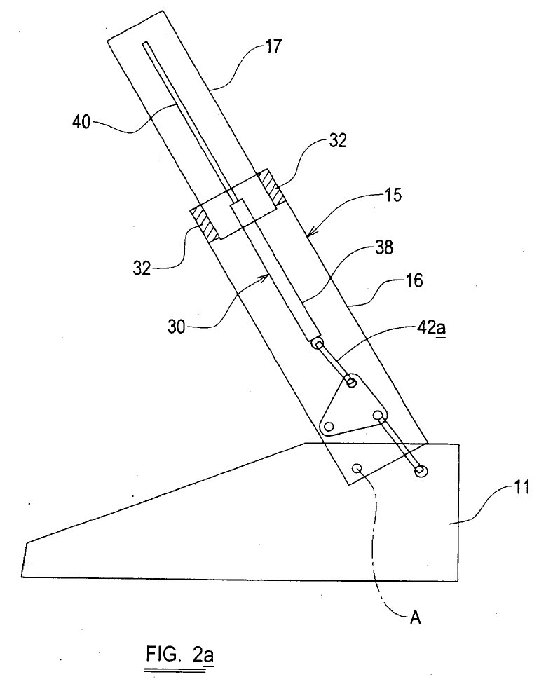

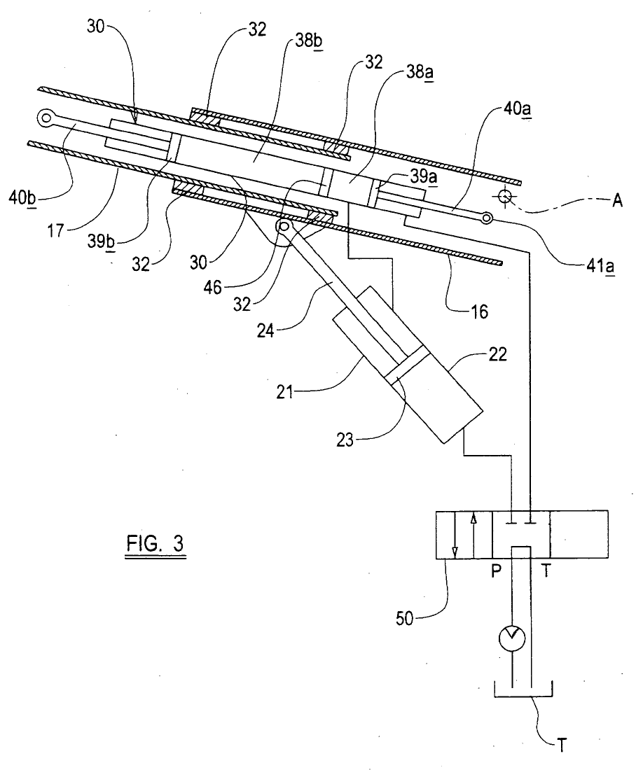

The machine 10 includes at least one hydraulically operated lifting actuator 21 which acts between the boom 15 and the body 11, the actuator 21 being in this example a linear actuator including a cylinder 22 pivotally connected to the body 11, and having provided within it, a piston 23 (see FIGS. 2 and 3) the piston 23 being connected to a piston rod 24 which in turn is pivotally connected to the boom 15.

The boom 15 is extendible and retractable by telescoping the second section 17 relative to the first section 16, telescoping being achieved in this example by a linear hydraulically operated actuator 30 (see FIGS. 2, 2a and 3) provided within the boom 15 and acting between the two boom sections 16, 17.

The lift actuator 21 and extension actuator 30 are operable under the control of an operator from within a cab 31 of the machine 10, as will be described in more detail below.

It will be appreciated that there is an overlap between the first 16 and second 17 boom sections which varies according to the extent of boom extension. As the load is extended further outwardly of the body 11, forces exerted on the structure of the boom 15 where the boom sections 16, 17 overlap will increase, these forces being exerted primarily through wear pads 32 provided within the boom 15, for example in the positions indicated in FIGS. 2 and 2a, to facilitate sliding of the second section 17 within the first boom section 16. Also, tipping forces which may tend to unbalance the machine 10 about a front wheel axis B will increase as the load is moved outwardly of the body 11. In FIG. 1 though, a stabilising leg 34 is shown deployed to obviate the effect of tipping forces, by raising the front wheels 13 off the ground and thus moving forward the point of contact of the machine 10 with the ground at the front end from where the boom 15 projects forwardly.

The greatest forces on the structure of the boom 15 and tipping forces are generated for any load, when the boom 15 is in a lowered position, generally horizontal, e.g. indicated by the boom in full lines in FIG. 1, and the boom 15 is telescoped outwardly to a maximum extent.

Thus conventionally for a rated maximum load, the extent to which the boom 15 can be extended is restricted so that there is always a minimum amount of overlap between the first and second boom sections 16, 17, and the minimum overlap permitted is determined for the worst case situation, i.e. for a maximum load with the boom 15 in a generally horizontal lowered position.

In FIG. 1, the line labelled C indicates the maximum upward reach which can conventionally be achieved as the boom 15 is raised, whilst retaining the same minimum boom section overlap through the whole range of boom positions about axis A.

However, as the boom 15 is raised, it will be appreciated that the load will move inwardly towards the body 11 in a generally horizontal sense. Thus when raised to the highest position 20, the minimum overlap of the boom sections 16, 17 set for when the boom 15 is horizontal, will be greater than that actually required for the prevailing conditions, i.e. it is not necessary for the minimum overlap to be as great as when the boom 15 is horizontal, because when the boom 15 is raised, the forces on the boom 15 structure and the tipping forces will reduce.

In FIG. 1 the upward reach of the boom 15 operated by a conventional method is indicated by line C, as is the additional upward reach by line D, which may be achieved by operating the machine 10 in accordance with the present invention.

Referring to FIG. 2 a means by which the method of the present invention may be performed is indicated.

In FIG. 2, as the boom 15 is raised, the geometry of the boom 15 is changed mechanically so as to reduce the minimum overlap of the boom sections 16, 17 as the boom 15 is raised.

It can be seen that the extension actuator 30 is in this example, mounted within the boom 15, and the actuator 30 includes a cylinder 38 and a piston 39, with the piston 39 connected to a piston rod 40. The piston rod 40 is connected to the second boom section 16 at a mounting position indicated at 41 whilst the cylinder 38 is mounted at a position in the boom 15 and is pivotally connected to a linkage mechanism provided by a simple link 42, which in turn is pivotally connected to the body 11 of the machine 10.

The geometry is such that as the boom 15 is raised by operation of the lift actuator 21, the changing angle between the boom 15 and the body 11 and hence between the cylinder 38 and the body 11, results in the link 42 moving the cylinder 38 linearly along the boom 15 outwardly of the body, and hence extending the second boom section 17, thus increasing the extent to which the boom 15 can be extended if the extension ram 30 is extended fully.

Thus with such an arrangement, the upward reach of the boom 15 when the extension ram 30 is fully extended, can be increased from line C as seen in FIG. 1, to line D. At the position of maximum height 20, the increased reach obtainable is substantial. This increase in reach is obtained by decreasing the extent of boom section minimum overlap as the boom 15 is extended, but the for the reasons set out above, this does not compromise the structure of the boom 15 or increase the tipping moment beyond design capability determined for the boom 15 when at the lowered position.

It can be seen that the cylinder 38 is mounted in the first boom section 16 by a mounting 45 which permits the cylinder 38 to be moved linearly in the boom 15 by the link 42 as described, constraining the cylinder 38 from other than linear movement, in the first boom section 16.

When the boom 15 is lowered from the highest position 20, of course the changing angle between the boom 15 and the body 11 will cause the link 42 to pull the cylinder 38 back along the boom 15 thus to increase the minimum overlap of the boom sections 16, 17 to that permitted if the extension actuator 30 was maximally extended.

FIG. 2a shows an arrangement very similar to that in FIG. 2, but modified. In the figure, the lift actuator 21 and other details have been omitted for clarity.

In FIG. 2a the boom 15 is mounted for movement about horizontal axis A not at a pivot position externally of the boom 15 as in FIG. 2, but at a pivot position internally of the boom 15.

Thus rather than providing a linkage mechanism which is a simple single link 42, a more complex linkage mechanism is provided which includes a first link 42a, a second link 42b, and an intermediate element 43.

The first link 42a is pivotally connected to the cylinder 38 of the extension actuator 30 (but in another embodiment could be pivotally connected to the piston rod 40) and to the intermediate element 43. The second link 42b is pivotally connected to the intermediate element 43 and to the body 11 of the machine 10. The intermediate element 43 is itself pivotally connected to the first boom part 16.

Thus due to this geometry, as the boom 15 is raised the permitted minimum boom overlap is reduced.

In FIG. 3 an hydraulic means for achieving performance of the invention is illustrated. Like parts to those illustrated in FIGS. 1 and 2 are indicated by the same references.

In this arrangement, the cylinder 38 of the extension actuator 30 is of a modified construction compared with the extension actuator 30 of the FIG. 1 arrangement. The cylinder 38 has first and second sections 38a, 38b isolated from one another by a radially extending wall 46.

The first cylinder section 38a has a first piston 39a slidable therein which is connected to a first piston rod 40a which is connected relative to the first boom section 16 of the machine 10 at a mounting position 41a.

The second cylinder section 38b also has a piston 39b slidable therein which is connected to a second piston rod 40b which is connected to the second boom section 17 at a mounting position 41b. Thus the extension actuator 30 may be extended by introducing hydraulic fluid into chambers at either non piston rod sides of the cylinder sections 38a, 38b.

The arrangement may be operated as follows.

To extend the boom 15, hydraulic fluid may be introduced into the second cylinder section 38b at the non piston rod side of the piston 39b, up until the piston 39b has moved to the full extent permitted, which will correspond to a condition when a minimum overlap between the boom sections 16, 17 will be maintained.

To raise the boom 15, hydraulic fluid supplied from a control valve 50 is fed to a non-piston rod side of the piston 23 of the lifting actuator 21. As the piston 23 moves to lift the boom 15, fluid will be displaced from piston rod side of the piston 23. In a conventional arrangement, this fluid may return directly to a tank T via the control valve 50, but in accordance with the invention, the displaced fluid is fed to the non piston rod side of the piston 39a of the second cylinder section 38a of the extension actuator 30. This fluid will thus move the piston 39a outwardly of the first cylinder section 38a to extend the piston rod 40a, which is fixed relative to the first boom section 16. Thus the second boom section 17 will be extended as the boom 15 is raised, thus decreasing the extent of minimum overlap between the boom sections 16, 17. Thus the minimum overlap is reduced when the boom 15 is raised towards at its highest position 20 compared with the minimum overlap to which the boom 15 is constrained, when the boom 15 is in its lowered position.

Fluid which is displaced from the piston rod side of the piston 39a of the first cylinder section 38a is returned to tank T via the control valve 50.

As the boom 15 is lowered, fluid is fed to the piston rod side of the piston 39a of the first cylinder section 38a, from the control valve 50, so that the maximum extension of the boom 15, and hence the minimum overlap of the boom sections 16, 17, is reduced. Fluid is displaced from the non piston rod side of the piston 39a of the first cylinder section 38a and is fed to the piston rod side of the lift actuator piston 23 thus resulting in the boom 15 lowering. Fluid displaced from the non piston rod side of the lift actuator piston 23 is returned to tank T via the control valve 50.

This embodiment of the invention may be implemented by modified means. For example, instead of the extension actuator 30 having the first and second cylinder sections 38a, 38b, so that the extension actuator 30 has an integral overlap actuator provided by the first cylinder part 38a, an overlap actuator separate from the extension actuator 30 may be provided which is operative to move the mounting position of the cylinder 38 of the extension actuator 30 as the boom 15 is raised and lowered, so that the minimum overlap when the boom 15 is raised is reduced compared with the minimum overlap permitted when the boom 15 is in the lowered position, e.g. a generally horizontal position as indicated in FIG. 1.

In an arrangement in which in addition to the lift actuator 21 there is a displacement actuator, usually on an opposite side of the boom pivot axis A to the lift actuator 21, hydraulic fluid for use in moving the mounting position of the extension actuator 30 or otherwise adjusting the minimum overlap permitted between boom sections 16, 17, may be derived from the displacement actuator instead of or in addition to the lift actuator 21. Such a displacement actuator typically is provided so that fluid displaced therefrom may be utilised to maintain the attitude of the load handling implement 19 automatically as the boom 15 is raised and lowered. Thus the displacement actuator may be connected in a hydraulic circuit with a loading implement actuator 53 seen in FIG. 1.

Fluid for use in adjusting the extent of minimum boom section overlap as the boom 15 is raised and lowered may be derived from a displacement actuator solely provided for that purpose, or from a displacement actuator of an automatic load handling implement 19 attitude maintaining hydraulic circuit.

In another arrangement, the boom 15 may have more than two sections 16, 17. In this case each of the sections may be extendible relative to the next adjacent section by respective extension actuator 30, of a construction similar to that shown in FIG. 3. The mounting position of at least one of the extension actuators 30 may be extended or retracted to vary the amount of minimum permitted overlap between adjacent boom sections, by hydraulic fluid displaced from the piston rod side of a piston 39a of another extension actuator 30. Thus for example referring to FIG. 3 again, the fluid displaced at the piston rod side of piston 39a in the first cylinder section 38a, may be fed to non piston rod side of a piston 39a of a second cylinder section 38a of a similar extension actuator 30 between the second and third telescoped boom sections, so that the minimum overlap between the second 17 and third boom sections is also adjusted as the boom 15 is raised and lowered.

In each arrangement where the geometry of the boom 15 is adjusted hydraulically to vary the minimum overlap permitted, the positions of pistons in the lift actuator and the or each overlap actuator are interdependent, and thus the geometry is automatically adjusted without operator intervention.

Referring again to FIG. 1, the provision of an electro-hydraulic arrangement for adjusting the minimum permitted overlap between the first and second boom sections 16, 17 as the boom 15 is raised and lowered, is illustrated.

In this arrangement, if desired, the lift actuator 21 may include on the piston rod 24 thereof, a linear encoder which provides an input to a controller 61 indicative of the actual extent of the piston rod 24 from the cylinder 22 thereof and hence the input is indicative of the actual boom position about pivot axis A. However there is shown a rotary encoder 64 positioned at the pivot axis A, to provide an input to the controller 61 indicative of the actual angular position of the boom 15 relative to the body 11 of the machine 10. Another preferably solid state sensor may be provided, in each case to enable the controller 61 absolutely to determine the boom 15 position about axis A.

Additionally, there is provided a linear encoder 60 or other preferably solid state sensor, to provide an input to the controller 61 indicative of the absolute extent of extension of the boom 15.

In this arrangement, the extension actuator 30 is capable of extending the boom 15 beyond a position of minimum desired overlap when the boom 15 is in the horizontal lowered position indicated in full lines in FIG. 1. However, the controller 61 operates according to an algorithm to restrict boom extension as the boom 15 is lowered to its lowered position, to maintain the overlap between boom sections 16, 17 at a minimum value constrained by the design of the boom 15 structure, rated when carrying a maximum load. However as the boom 15 is raised, and a decreased minimum overlap between the boom sections 16, 17 can be tolerated, the controller 61 operates according to the algorithm, to permit the extension actuator 30 to be further extended so as to permit further outward telescoping of the boom sections 16, 17, thus to reduce the minimum overlap permissible and thus to increased upward reach. This may be achieved by the controller 61 operating mechanical stops, or opening a relief valve in a hydraulic feed line to the extension actuator 30 so that pressure further to extend the extension actuator 30 cannot be developed, or by any other operation. For example, the controller 61 may not permit further extension of the actuator 30 by inhibiting operation of the electronically controlled valve 50.

If desired the controller 61 may control the extension actuator 30 operation to vary the amount of minimum permitted boom section overlap depending upon the magnitude of a load carried by the boom 15, yet further extension and thus reduced permitted minimum overlap being permitted where the load is less then the maximum rated load. A measure of load may be determined by sensing the hydraulic pressure at the non piston rod side of the piston 23 of the lift actuator 21 for example.

Various other modifications may be made without departing from the scope of the invention. For example, although the invention has been described in relation to a wheeled loader in telescope handler machine 10, the invention may be applied to any other loader machine, such as for example only, a mobile loader having one or more pairs of tracks instead of wheels, or to a crane, or to any other machine having a telescopic boom for handling loads.

1. A method of operating a machine which has a boom mounted at or adjacent one end to a body of the machine, and the boom having at the other end, a load handling implement, the boom including at least two sections, with one of the sections, being telescoped within the other, there being at least one extension actuator to adjust the extent of telescoping, and the boom being moveable by at least one lift actuator for movement between a lowered position to a raised position, the method including preventing the relative extension of the boom sections to provide a minimum overlap between the boom sections when the boom is at the lowered position which is greater than the minimum overlap permitted when the boom is at a raised position.

2. A method according to claim 1 wherein the method includes mechanically adjusting the boom geometry to reduce the permitted minimum overlap between the boom sections as the boom is raised.

3. A method according to claim 2 wherein the extension actuator for relatively extending and retracting the boom sections is mounted at one end relative to the first boom section and at the other end relative to the second boom section, one of the first and second actuator mounting positions being moved relative to the respective boom section, as the boom is raised or lowered.

4. A method according to claim 3 wherein a linear actuator is provided within the boom, one of the mounting positions being moveable linearly of the boom as the boom is raised or lowered, by a linkage mechanism between the actuator and the body of the machine.

5. A method according to claim 4 wherein the linkage mechanism includes a simple link which extends directly between the actuator and the body of the machine.

6. A method according to claim 4 wherein the linkage mechanism includes a first link which extends between the actuator and an intermediate element to which the first link is pivotally connected, and a second link pivotally connected to the intermediate element and the body of the machine, the intermediate element being pivotally connected to the first boom section.

7. A method according to claim 1 wherein the method includes adjusting the boom geometry hydraulically to reduce the permitted minimum overlap between the boom sections as the boom is raised.

8. A method according to claim 7 wherein the lift actuator is hydraulically operated to raise and lower the boom, the method including directing hydraulic fluid from the lift actuator to an overlap actuator which adjusts the boom geometry as the boom is raised or lowered.

9. A method according to claim 7 wherein there is a displacement linear actuator including a piston and cylinder which are relatively moved as the boom is raised and lowered to displace hydraulic fluid, the method including directing hydraulic fluid from the displacement actuator to an overlap actuator which adjusts the boom geometry as the boom is raised or lowered.

10. A method according to claim 8 wherein the extension actuator for relatively extending and retracting the boom sections includes a cylinder having a first section isolated from a second section, the first section and a first piston slidable in the first section providing the overlap actuator, and the second cylinder section and a second piston slidable within the second section providing the extension actuator, one side of the first piston being connected hydraulically to one side of the piston of the lift or displacement actuator, so that the positions of the respective pistons are interdependent.

11. A method according to claim 8 wherein where the boom includes more than two telescoped sections, each of the sections is extendible relative to the next adjacent section by a respective extension actuator, and at least one of the extension actuators is extended or retracted to vary the amount of minimum permitted overlap between the adjacent boom sections, by hydraulic fluid displaced from another extension actuator or from the lift and/or displacement actuator.

12. A method according to claim 1 wherein the method includes adjusting the boom geometry electro-hydraulically to reduce the permitted minimum overlap between the boom sections as the boom is raised.

13. A method according to claim 12 wherein the extension actuator is capable of relatively extending the boom sections at all boom lift positions so as to provide the minimum overlap between the boom sections boom which is required when the boom is in its fully raised position, extension actuator extension being restricted by a controller for all lifting positions below the fully raised positions in response to inputs from sensors which sense the actual relative extension of the boom sections and the position of the boom between its raised and lowered positions.

14. A method according to claim 13 wherein the sensors include a linear encoder to determine the axial position of a piston in a cylinder of an actuator where the actuator is a linear actuator.

15. A method according to claim 13 wherein the sensors include a rotary encoder at a pivot mounting where the boom is mounted to the body of the machine.

16. A method according to claim 13 wherein the sensors include an encoder to determine the actual extent of telescoping of the first and second boom sections.

17. A method according to claim 13 wherein the controller controls the extension actuator operation to vary the amount of permitted minimum boom overlap depending upon the magnitude of a load carried by the boom as well as the position of the boom between the raised and lowered positions and the extent of extension of the extension actuator.

18. A machine having a boom for handling loads, the machine including a boom mounted at or adjacent one end to a body of the machine, and the boom having at the other end, a load handling implement, the boom including at least two sections, with one of the sections, being telescoped within the other, there being at least one extension actuator to adjust the extent of telescoping, and the boom being moveable by at least one lift actuator for movement between a lowered position to a raised position, means being provided to prevent the relative extension of the boom sections to provide a minimum overlap between the boom sections when the boom is at the lowered position which is greater than the minimum overlap permitted when the boom is at a raised position.
